(19) United States
(12) Patent Application Publication
(10) Pub. No.: US 2008/0001696 A1
(43) Pub. Date: Jan. 3, 2008

(54) Inductive power transfer system for underwater applications

(76) Inventors: Robert Coulson, Boca Raton, FL (US); Joe Lambiotte, West Palm Beach, FL (US); Tom Pantelakis, Coral Springs, FL (US)

Correspondence Address: AKERMAN SENTERFITT, P.O. BOX 3188, WEST PALM BEACH, FL, 33402-3188, US

(21) Appl. No.: 11/582,033

(22) Filed: Oct. 17, 2006

Related U.S. Application Data
(60) Provisional application No. 60/727,317, filed on Oct. 17, 2005.

(51) Int. Cl. H01F 21/04

(52) U.S. Cl. 336/115

(57) ABSTRACT

An underwater inductive power transfer system enabling power to be transferred from a docking station to another underwater system without direct physical electrical contact between conductors. The power transfer system may include a probe configured to be inserted into a probe receiving chamber. The probe may include a plurality of partial transformers positioned to be aligned with a plurality of transformers proximate to a surface forming a probe receiving chamber. The probe may include partial transformers positioned on opposite sides of the probe, and the prove receiving cavity may include partial transformers positioned on opposite sides of the cavity. The probe receiving chamber may be sized such that the partial transformers in the probe may be positioned in close proximity to the partial transformers in the sidewalls forming the probe receiving chamber so that power may be transmitted between the transformers.

### CROSS-REFERENCE TO RELATED APPLICATIONS

This application claims the benefit of U.S. Provisional Patent Application Ser. No. 60/727,317 filed Oct. 17, 2005.

### STATEMENT REGARDING FEDERALLY FUNDED RESEARCH

The U.S. Government has a paid-up license in this invention and the right in limited circumstances to require the patent owner to license others on reasonable terms as provided for by the terms of N0014-98-1-0861 awarded by the Office of Naval Research.

### FIELD OF THE INVENTION

This invention is directed generally to inductive power transfer systems, and more particularly to power transfer between underwater systems, such as for underwater vehicles.

### BACKGROUND

Underwater vehicles have proven useful for scientists, researchers, underwater recover efforts and other endeavors. One particular type of underwater vehicles, autonomous underwater vehicles (AUVs), are unmanned and untethered submarines that provide researchers with a simple, long-range and cost effective solution with which to gather data. Common applications for deploying AUVs include oceanographic sampling, bathymetry profiling, underwater system inspection, and military mine counter-measure (MCM) operations. Some of these missions require long survey operations. For these missions, long endurance, readiness, and full autonomy are important capabilities for the AUV.

The ability to dock autonomous underwater vehicles AUVs is a key component in extending their endurance capabilities and removing the requirement for the continual tending of a surface support vessel. A docking system consists of a docking station, which is commonly situated on the ocean floor, and a docking payload, which is situated on an AUV. Docking allows an AUV to recharge its batteries, download collected data, and upload new mission plans. A docking station also affords safe dockage between scheduled or triggered deployments or while waiting to be recovered. The use of a docking stations in an AUV mission creates an enormous saving in man-power and ship-time requirements for the collection of spatial and temporal data, limited only to deployment and recovery of the vehicle and docking station. In other situations, operating an AUV without a dock is difficult or impossible, such as in adverse weather conditions.

Conventional power transfer systems, such as battery charging systems, require physical contact between electrical conductors, such as through electrical connectors. While such systems work well above water, such systems are fraught with problems when used underwater, especially in saltwater. For instance, exposed metal is highly susceptible to fouling and marine growth, with heavy marine growth occurring in as little as ten days of exposure. Such fouling prevents successful attachment of exposed metal connectors to a power transfer system of a docking station. Additionally, direct electrical contact systems are susceptible to corrosion problems associated with stray currents and ground loops. Such corrosion problems cause premature failure of the recharging systems. Thus, a need exists for a system capable of transferring power from a docking station to an AUV without requiring the use of exposed metal connectors.

### SUMMARY OF THE INVENTION

This invention relates to a power transfer system usable with an underwater system, such as, but not limited to, an autonomous underwater vehicle. In one embodiment, the autonomous underwater vehicle may be an unmanned, untethered submarine that provides marine researchers with a simple, long-range and low-cost mechanism for gathering oceanographic data. The power transfer system may be configured to facilitate the transfer of power from a docking station to the underwater vehicle while in water, such as an ocean or other water body. The power transfer system may be particularly suited for use in saltwater where conventional systems have failed. The power transfer system may be configured such that power may be transmitted between the docking station and the underwater vehicle without necessitating physical contact between connectors. Rather, the power transfer system may include a plurality of transformers used to transmit power via inductance. Thus, the power transfer system overcomes the fouling and marine growth issues common in saltwater environments.

The power transfer system may be formed from a probe movably coupled to a docking station. At least one first partial transformer may be positioned in the probe at a first side of the probe that is generally orthogonal to a longitudinal axis of the probe and at least one second partial transformer may be positioned in the probe at a second side of the probe opposite to the first side of the probe. The power transfer system may include a power transfer device coupled to the underwater vehicle. The power transfer device may include a probe receiving chamber. The probe receiving chamber may extend through the underwater vehicle to exhaust water and debris from the probe receiving chamber. The power transfer device may include a third partial transformer positioned at a surface of the probe receiving chamber and a fourth partial transformer positioned at a surface of the probe receiving chamber generally opposite to the third partial transformer. The third and fourth partial transformers may be positioned in the underwater vehicle such that when the probe is inserted into the probe receiving chamber, the third partial transformer is positioned proximate to the first partial transformer in the probe and the fourth partial transformer is positioned proximate to the second partial transformer in the probe. In this position, the first and third partial transformers form a first inductive loop and the second and fourth partial transformers form a second inductive loop. The first, second, third and fourth partial transformers form a first pair of transformers.

In one embodiment, the first pair of transformers form a generally linear configuration. When the probe is inserted into the probe receiving chamber, gaps are formed from each side of the probe between the probe receiving chamber. The total distance of a sum of a first distance between the first and third partial transformers and a second distance between the second and fourth partial transformers may be less than about 0.1 inch. As the probe moves from side to side in the probe receiving chamber, the effective average gap remains constant because as one gap grows, the other gap shrinks. This constant effective average gap keeps that leakage inductance relatively constant, which enables a fixed value capacitor to be used to cancel out the leakage inductance at a given frequency. Canceling the leakage inductance greatly increases the amount of power that may be transferred.

In another embodiment, the power system may include a second pair of transformers. The second pair of transformers are formed from fifth and sixth partial transformers positioned in the probe and generally opposite to each other, and from seventh and eight partial transformers positioned in the underwater vehicle opposite to each other and proximate to a surface of the probe receiving chamber. The second pair of transformers may be positioned in a generally linear formation that is aligned with the first pair of transformers and beside the first pair of transformers. Alternatively, the second pair of transformers may be positioned in a generally linear formation that is generally orthogonal to the first pair of transformers.

The power transfer system may also include features for aligning the probe in the probe receiving chamber. For instance, the probe may include a tapered tip to facilitate insertion of probe into the probe receiving chamber. The power transfer system may also include an alignment guide for aligning the probe and the first and second partial transformers with the third and fourth partial transformers. In one embodiment, the alignment guide may be formed from a pin extending from the probe and a slot in a wall forming the probe receiving chamber for receiving the pin, or vice versa. The power transfer system may also include a linear actuator for extending the probe from the docking station into the probe receiving chamber.

An advantage of this invention is that the configuration of the partial transformers in the probe and in the wall forming the probe receiving chamber enables the average effective gap to remain constant, thereby keeping the leakage inductance relatively constant. Keeping the leakage inductance constant permits a capacitor with a fixed value to be used to cancel out the leakage inductance at a particular frequency. Canceling the leakage inductance greatly increases the amount of power transfer capable of being transferred by the system. Such increased power transfer increases the available power supply to the underwater vehicle, thereby increasing the options available to the system.

Another advantage of this system is that the power may be transferred to the power system of the underwater vehicle without physical contact occurring between electrical elements in the probe and in the underwater vehicle, thereby overcoming the problems associated with fouling, marine growth, stray currents and corrosion.

Yet another advantage of this system is that the probe may be also be used as an anchor to lock the underwater vehicle into position in relation to the docking station. Doing so not only retains the vehicle securely in the dock without the need to a secondary capture actuator, but also allows for the accurate alignment of multiple RF communications patch antenna establishing a high speed data link between the vehicle payload and the dock station.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a partial cross-sectional view of the power transfer system of this invention positioned in a docking station and in an underwater vehicle.

FIG. 2 is an exploded perspective view of another embodiment of the power transfer system including the alignment device and two pairs of transformers generally aligned with each other, whereby each pair is positioned in a generally linear configuration.

FIG. 3 is a cross-sectional view of an embodiment of the probe in which the probe has first and second pairs of transformers positioned generally aligned with each other, as shown in FIG. 1.

FIG. 4 is a cross-sectional view of an alternative embodiment of the probe in which the probe has first and second pairs of transformers positioned generally orthogonal to each other.

FIG. 5 is a schematic view of the power transfer system.

FIG. 6 is a table of the inductive power transfer results that occur using two pairs of transformers.

FIG. 7 is a graph of the power transfer efficiency of the power transfer system.

### DETAILED DESCRIPTION OF THE INVENTION

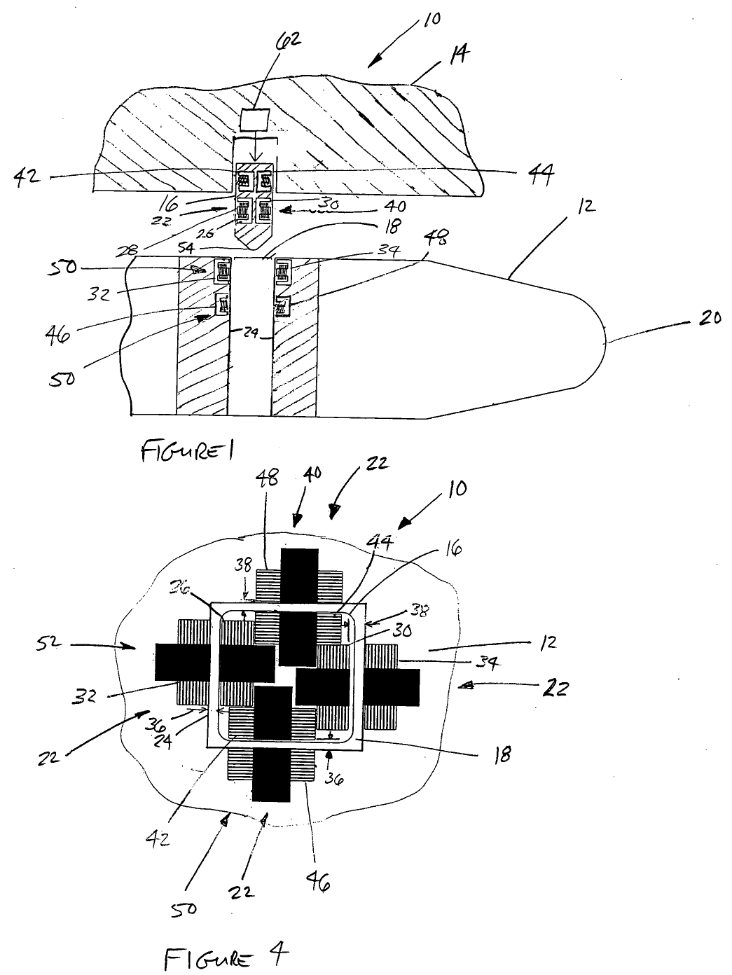

As shown in FIGS. 1-7, this invention is directed to a power transfer system 10 usable with an underwater system 12, such as, but not limited to, an autonomous underwater vehicle 12. In one embodiment, the autonomous underwater system 12 may be an unmanned, untethered submarine that provides marine researchers with a simple, long-range and low-cost mechanism for gathering oceanographic data. The power transfer system 10 is configured to facilitate the transfer of power from a docking station 14 to the underwater vehicle 12 while in water, such as an ocean or other water body. The power transfer system 10 is particularly suited for use in saltwater where conventional systems have failed but may be used in other water types as well. The power transfer system 10 has been configured such that power may be transmitted between the docking station 14 and the underwater vehicle 12 without necessitating physical contact between connectors. Rather, the power transfer system 10 includes a plurality of transformers 16 used to transmit power via inductance. Thus, the power transfer system 10 overcomes the fouling and marine growth issues common in saltwater environments and the corrosion and ground loop problems associated with stray currents.

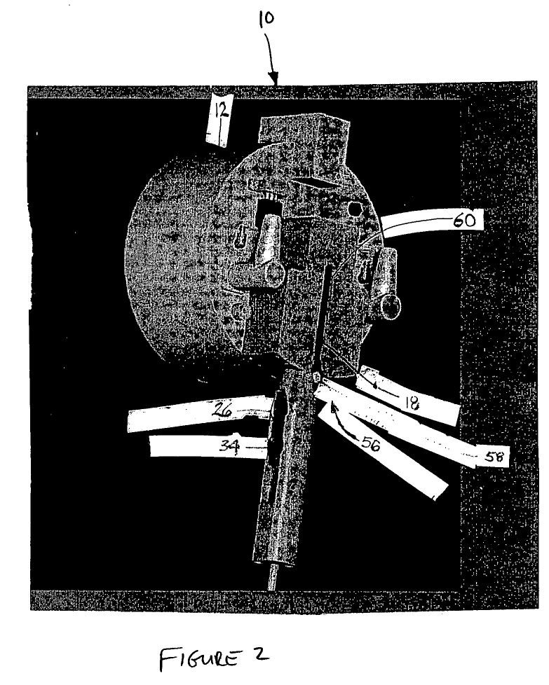

As shown in FIGS. 1 and 2, the power transfer system 10 may be formed from a probe 16 movably coupled to the docking station 14 and a probe receiving chamber 18 positioned in the underwater vehicle 12, or vice versa. In one embodiment, as shown in FIG. 1, the probe receiving chamber 18 may be positioned proximate to a tip 20 of the underwater vehicle 12. The probe receiving chamber 18 may be positioned in the underwater vehicle 12 in other locations as well. The probe receiving chamber 18 may be configured such that the probe 16 may be inserted into the probe receiving chamber 18. In one embodiment, the probe receiving chamber 18 may extend completely through the under water vehicle to enable fluids and debris to be expelled from the probe receiving chamber 18 when the probe 16 is inserted.

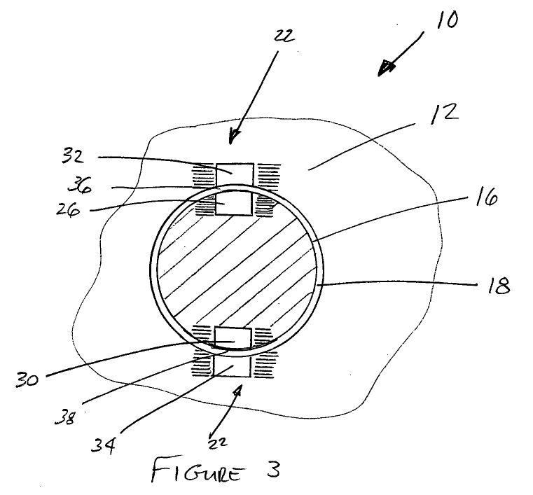

The probe 16 may be formed from any appropriate size and shape. In one embodiment, the probe 16 may have a generally cylindrical cross-section, as shown in FIG. 3. In other embodiments, the probe 16 may have a rectangular cross-section, as shown in FIG. 4, or may have other shaped cross-sections. The probe 16 may have a diameter of about two inches, however, the diameter may be larger or smaller in other embodiments. The probe 16 may have a length of about six inches and other lengths in other embodiments. The probe 16 may be formed from any material having sufficient structural integrity. Preferably, the probe 16 is constructed from materials that are resistant to the corrosive action of saltwater, such as, but not limited to, anodized aluminum.

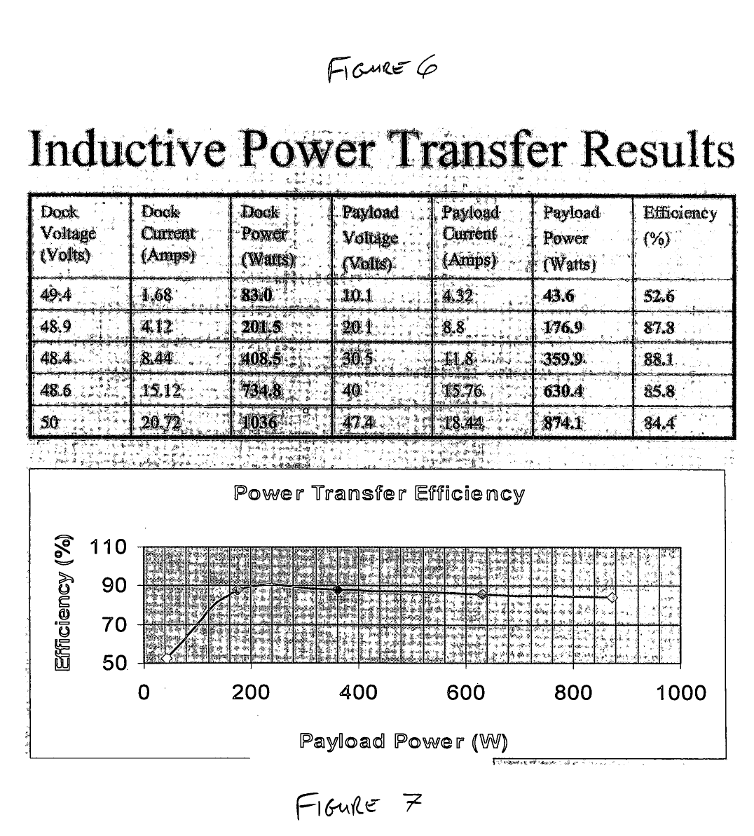

The power transfer system 10 may include transformers 22 for transmitting power from partial transformers 22 in the probe 16 to partial transformers 22 in the wall 24 forming the probe receiving chamber 18. The partial transformers 22 in the probe 16 and the partial transformers 22 in the wall 24 of the probe receiving chamber 18 form inductive loops such that power can be passed from the probe 16 to the underwater vehicle 12 to recharge a power source, such as one or more batteries, on the underwater vehicle 12. In one embodiment, the power transfer system 10 may be configured to transfer about one kilowatt of power at 50 volts and 20.7 amps using four inductive loops, as shown in FIG. 6. The power transfer system 10 may be configured to transfer about up to about one kilowatt of power at up to 70 volts and up to 30 amps. The power transfer efficiency of the system is shown in FIG. 7.

As shown in FIGS. 1-5, the power transfer system 10 may include one or more pairs of transformers 22 forming inductive loops. For instance, the power transfer system 10 may include a first partial transformer 26 positioned in the probe 16 proximate to an outer surface 28 of the probe 16. A second partial transformer 30 may be positioned in the probe 16 proximate to the outer surface 28 and generally opposite to the first partial transformer 26. The power transfer system 10 may also include a power transfer device 40 positioned in the underwater vehicle 12. The power transfer device 10 may be formed from third and fourth partial transformers 32, 34 positioned in the wall 24 forming the probe receiving chamber 18. The third partial transformer 32 may be positioned on a first side and in a wall 24 in close proximity to a surface forming the probe receiving chamber 18. The fourth partial transformer 34 may be positioned on a second side of the probe receiving chamber 18 that is generally opposite to the third partial transformer 34 and in a wall 24 in close proximity to a surface forming the probe receiving chamber 18. The first and third partial transformers 26, 32 form a first inductive loop, and the second and fourth partial transformers 30, 34 for a second inductive loop.

The partial transformers 26, 30, 32 and 34 may be positioned and the probe receiving chamber 18 and the probe 16 sized such that a total sum of the distance 36 between the first and third partial transformers 26, 32 and the distance 38 between the second and fourth partial transformers 30, 34 is less than about 0.1 inch. Such a configuration enables successful power transmission to occur. This distance is between the closest faces of the first and third partial transformers 26, 32 and the closest faces of the second and fourth partial transformers 30, 34. A thin layer, such as about 1/1000 inch thick, of a protective material, such as a potting material, may cover the transformers 26, 30, 32 and 34. The thickness of this material is included within the 0.1 inch spacing, and therefore does not effect the spacing of the transformers 26, 30, 32 and 34.

In addition, the partial transformers 26, 30, 32 and 34 may be aligned in a linear formation. The second and fourth partial transformers 30, 34 may be positioned generally about 180 degrees from the first and third partial transformers 26, 32 which effectively places the inductive loops in series. This configuration maintains the total sum of the distances 36, 38 as a constant number because if the probe is offset to favor one side or the other of the probe receiving chamber 18, the total sum of the distances does not change and thus, the sum total of the power transmitted across the partial transformers 26, 30, 32 and 34 does not change. In particular, as shown in FIGS. 3-5, as the probe 16 moves from side to side, the effective average gap formed by the distances 36, 38 on both sides of the probe 16 remains constant. As one gap gets larger, the opposite gap gets smaller. A constant gap keeps the leakage inductance relatively constant. This enables a capacitor with a fixed value to be used to cancel out the leakage inductance at a given frequency. The canceling of the leakage inductance greatly increases the amount of power transfer capability of the power transfer system 10 and increases the efficiency of the power transfer system 10.

The power transfer system 10 may include a second pair 50 of partial transformers 22 forming two inductive loops. In particular, the power transfer system 10 may include a fifth partial transformer 42 positioned in the probe 16 proximate to the outer surface 28 of the probe 16. A sixth partial transformer 44 may be positioned in the probe 16 proximate to the outer surface 28 and generally opposite to the fifth partial transformer 42. The power transfer device 40 positioned in the underwater vehicle 12 may be formed from seventh and eighth partial transformers 46, 48 positioned in the wall 24 forming the probe receiving chamber 18. The seventh partial transformer 46 may be positioned on a first side and in a wall 24 in close proximity to a surface forming the probe receiving chamber 18. The eighth partial transformer 48 may be positioned on a second side of the probe receiving chamber 18 that is generally opposite to the seventh partial transformer 46 and in a wall 24 in close proximity to a surface forming the probe receiving chamber 18. In one embodiment, the second pair 50 of transformers, 42, 44, 46 and 48 may be positioned in a generally linear formation that is aligned with the first pair 52 of transformers 26, 30, 32 and 34. The second pair 50 may be positioned beside the first pair 52, as shown in FIG. 1. In another embodiment, the second pair 50 of transformers, 42, 44, 46 and 48 may be positioned in a generally linear formation that is generally orthogonal to the first pair 52 of transformers 26, 30, 32 and 34, as shown in FIG. 4. The fifth and seventh partial transformers 42, 46 form a third inductive loop, and the sixth and eight partial transformers 44, 48 for a fourth inductive loop. The power transfer system 10 is not limited to two pairs of transformers 22 but may include additional pairs of transformers 22 as well.

The power transfer system 10 may include features for aligning the probe 16 and the first and second pairs 52, 50 within the probe receiving chamber 18. For instance, the power transfer system 10 may include a tapered tip 54. The tapered tip 54 may have a generally conical shape, or other appropriate shape, for guiding the probe 16 into the probe receiving chamber 18. The power transfer system 10 may also include an alignment guide 56 for aligning the probe 16 and the first and second partial transformers 26, 30 with the third and fourth partial transformers 32, 34. The alignment guide 56 may be any device capable of aligning the first and second partial transformers 26, 30 in the probe 16 with the third and fourth partial transformers 32, 34 in the wall 24 forming the probe receiving chamber 18. The alignment guide 56 may be formed from a pin 58 extending from the probe 16 and a slot 60 in the wall 24 forming the probe receiving chamber 18 for receiving the pin 58, or vice versa.

The power transfer system 10 may include a linear actuator 62 for extending the probe 16 from the docking station 14 into the probe receiving chamber 18. The linear actuator 62 may be any device capable of extending and retracting the probe 16.

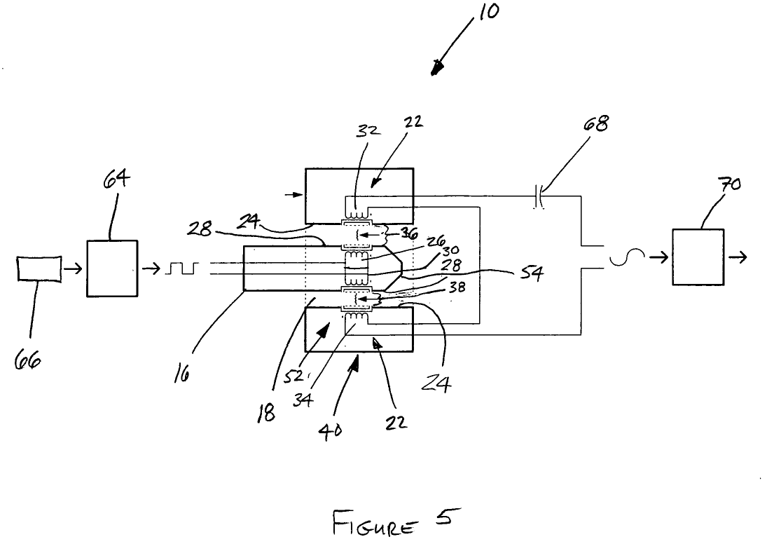

As shown in FIG. 5, the power transfer system 10 may include a fixed frequency oscillator 64 that may be in communication with a direct current (DC) power source 66. The fixed frequency oscillator 64 may be in communication with the first and second pairs of transformers 52, 50 in the probe 16. The power transfer system 10 may also include a capacitor 68 in communication with one loop of transformers 22, such as the third and seventh partial transformers 32, 46 or the fourth and eighth partial transformers 34, 48. The power transfer system 10 may also include a bridge rectifier 70 in communication with the third and fourth partial transformers 32, 34 and in one embodiment, the third, fourth, seventh and eighth partial transformers 32, 34, 46 and 48. The bridge rectifier 70 converts alternating current (AC) to DC to be supplied to the underwater vehicle 12 to charge the electrical system, such as batteries.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. An inductive power transfer system suitable for underwater applications, comprising:
a probe movably coupled to a docking station;
at least one first partial transformer positioned in the probe at a first side of the probe that is generally orthogonal to a longitudinal axis of the probe;
at least one second partial transformer positioned in the probe at a second side of the probe opposite to the first side of the probe;
a power transfer device coupled to an underwater device, wherein the power transfer device comprises a probe receiving chamber, a third partial transformer positioned at the probe receiving chamber, and a fourth partial transformer positioned at the probe receiving chamber generally opposite to the third partial transformer;
wherein the third and fourth partial transformers are positioned in the underwater device such that when the probe is inserted into the probe receiving chamber, the third partial transformer is positioned proximate to the first partial transformer in the probe and the fourth partial transformer is positioned proximate to the second partial transformer in the probe, whereby the first and third partial transformers form a first inductive loop and the second and fourth partial transformers form a second inductive loop; and
wherein the first, second, third and fourth partial transformers form a first pair of transformers.

2. The inductive power transfer system of claim 1, wherein a total distance of a sum of a distance between the first and third partial transformers and a distance between the second and fourth partial transformers is less than about 0.1 inch.

3. The inductive power transfer system of claim 1, further comprising a second pair of transformers.

4. The inductive power transfer system of claim 3, wherein the second pair of transformers are formed from fifth and sixth partial transformers positioned in the probe and generally opposite to each other, and from seventh and eight partial transformers positioned in the underwater device opposite to each other and proximate to a surface of the probe receiving chamber.

5. The inductive power transfer system of claim 4, wherein the second pair of transformers are positioned in a generally linear formation that is aligned with the first pair of transformers and beside the first pair of transformers.

6. The inductive power transfer system of claim 4, wherein the second pair of transformers are positioned in a generally linear formation that is generally orthogonal to the first pair of transformers.

7. The inductive power transfer system of claim 1, wherein the probe includes a tapered tip to facilitate insertion of probe into the probe receiving chamber.

8. The inductive power transfer system of claim 1, further comprising an alignment guide for aligning the probe and the first and second partial transformers with the third and fourth partial transformers.

9. The inductive power transfer system of claim 8, wherein the alignment guide comprises a pin extending from the probe and a slot in a wall forming the probe receiving chamber for receiving the pin.

10. The inductive power transfer system of claim 1, wherein the probe has a generally cylindrical cross-section.

11. The inductive power transfer system of claim 1, further comprising a linear actuator for extending the probe from the docking station into the probe receiving chamber.

12. The inductive power transfer system of claim 1, wherein the probe receiving chamber extends through the underwater device to exhaust water and debris from the probe receiving chamber.

13. An inductive power transfer system suitable for use with an underwater vehicle, comprising:
a probe movably coupled to a docking station;
first and second pairs of transformers, wherein the first pair of transformers is formed from first, second, third, and fourth partial transformers and the second pair of transformers is formed from fifth, sixth, seventh and eight partial transformers;
wherein the first partial transformer is positioned in the probe at a first side of the probe that is generally orthogonal to a longitudinal axis of the probe;
wherein the second partial transformer is positioned in the probe at a second side of the probe opposite to the first side of the probe;
wherein the fifth partial transformer is positioned in the probe at a side of the probe that is generally orthogonal to a longitudinal axis of the probe;
wherein the sixth partial transformer is positioned in the probe at a side of the probe opposite to the fifth partial transformer;
a power transfer device coupled to the underwater vehicle, wherein the power transfer device comprises a probe receiving chamber, a third partial transformer positioned at the probe receiving chamber, a fourth partial transformer positioned at the probe receiving chamber generally opposite to the third partial transformer, a seventh partial transformer positioned at the surface of the probe receiving chamber, and an eighth partial transformer positioned at the surface of the probe receiving chamber generally opposite to the seventh partial transformer;
wherein the third and fourth partial transformers are positioned in the underwater vehicle such that when the probe is inserted into the probe receiving chamber, the third partial transformer is positioned proximate to the first partial transformer in the probe and the fourth partial transformer is positioned proximate to the second partial transformer in the probe, whereby the first and third partial transformers form a first inductive loop and the second and fourth partial transformers form a second inductive loop; and
wherein the seventh and eighth partial transformers are positioned in the underwater vehicle such that when the probe is inserted into the probe receiving chamber, the seventh partial transformer is positioned proximate to the fifth partial transformer in the probe and the eighth partial transformer is positioned proximate to the sixth partial transformer in the probe, whereby the fifth and seventh partial transformers form a third inductive loop and the sixth and eighth partial transformers form a fourth inductive loop.

14. The inductive power transfer system of claim 13, wherein a total distance of a sum of a distance between the first and third partial transformers and a distance between the second and fourth partial transformers is less than about 0.1 inch.

15. The inductive power transfer system of claim 14, wherein a total distance of a sum of a distance between the fifth and seventh partial transformers and a distance between the sixth and eighth partial transformers is less than about 0.1 inch.

16. The inductive power transfer system of claim 13, wherein the second pair of transformers are positioned in a generally linear formation that is aligned with the first pair of transformers and positioned beside the first pair of transformers.

17. The inductive power transfer system of claim 13, wherein the second pair of transformers are positioned in a generally linear formation that is generally orthogonal to the first pair of transformers.

18. The inductive power transfer system of claim 13, wherein the probe includes a tapered tip to facilitate insertion of probe into the probe receiving chamber.

19. The inductive power transfer system of claim 13, further comprising an alignment guide for aligning the probe and the first and second partial transformers with the third and fourth partial transformers.

20. The inductive power transfer system of claim 19, wherein the alignment guide comprises a pin extending from the probe and a slot in a wall forming the probe receiving chamber for receiving the pin.

21. The inductive power transfer system of claim 13, further comprising a linear actuator for extending the probe from the docking station into the probe receiving chamber.

22. The inductive power transfer system of claim 13, wherein the probe receiving chamber extends through the underwater vehicle to exhaust water and debris from the probe receiving chamber.
